(19) United States
(12) Patent Application Publication
(10) Pub. No.: US 2025/0083364 A1
(43) Pub. Date: Mar. 13, 2025

(54) MULTILAYER DEVICE FOR A MOULD FOR THE MANUFACTURE OF COMPOSITE PARTS WITH THERMAL BLOCKING BELT

(71) Applicant: ECOLE NATIONALE SUPERIEURE D'ARTS ET METIERS, Paris (FR)

(72) Inventors: Marc LEGRAND, Saint Amand les Eaux (FR); Olivier DUTHOIT, Fâches-Thumesnil (FR)

(21) Appl. No.: 18/576,234

(22) PCT Filed: May 19, 2022
(86) PCT No.: PCT/FR2022/050952

§ 371 Date: Jan. 3, 2024

(30) Foreign Application Priority Data
Jul. 8, 2021 (FR) 2107440

(51) Int. Cl. B29C 33/02; B29C 33/38; B29L 31/30

(52) U.S. Cl. CPC B29C 33/02; B29C 33/3807; B29L 2031/3085

(57) ABSTRACT

The invention relates to a multilayer device for a mould having a surface layer and at least one reinforcing layer made of composite material coated with a thermosetting material. The surface layer includes a functional face of complex shape constituting a negative of a composite part to be manufactured. The multilayer device further includes at least one first heating network configured to heat the functional face and to implement a thermal treatment surface for the composite part and at least one second heating network configured to heat the surface layer around the functional face and to define at least one thermal blocking belt at the at least one periphery of the thermal treatment surface.

### TECHNICAL FIELD

The present invention relates to the manufacture of composite parts and more particularly relates to a mold multilayer device with an endogenous heating for making fibrous preforms of composite parts, for example aeronautical parts, wind turbine blades or satellite parabolas. Although the multilayer device is particularly intended for these applications, it could also be implemented on preforms of various items in particular having large surfaces.

### PRIOR ART

The composite parts with organic matrices are obtained by carrying some steps by means of a mold, including a pressurization and heating step intended to transform the resin. Depending on the retained technique, heating of the mold may be either exogenous or endogenous.

The exogenous heating is obtained in an autoclave or an oven, the heat being transmitted by convection to the mold. This technique is highly energy intensive given the low thermal efficiency of these installations and their high inertia. In addition, this technique is not suitable for the production of large-sized and large-series parts. Indeed, the size of the autoclave limits the dimensions of the manufactured composite parts. Furthermore, the necessary significant cooling time limits the rate of production of the composite parts.

The endogenous heating consists in embedding heating elements into the mold which, according to a first variant, consist of heating tubes enabling the passage of a heat-transfer fluid which supplies calories to the matrix. According to a second variant, metal molds are equipped with induction heating devices; this technique is very expensive, energy-intensive and not very suitable for large heating surfaces. According to a third variant, metal molds are equipped with resistive heating cartridges; this technique is also energy-intensive and not very suitable for large heating surfaces. These aforementioned three variants are relatively barely exploitable because of the installation constraints, in particular for making large-dimension composite parts, and because of the large energy consumed.

A fourth variant consists in using a mold made of composite materials equipped with a resistive heating system, as described in patent FR2956555B1. This fourth variant is advantageous because the energy consumption is much lower than the previous variants.

The European patent EP2643151B1 is also known, which relates to the repair of composite parts or portions of composite parts using a main heating mat and satellite heating mats arranged in contiguously to the main heating mat. This allows compensating for the thermal losses at the periphery of the main heating mat and, thus, rapidly stabilizing the temperatures all over the area of the structure covered by the main heating mat. This implementation is difficult to consider for the manufacture of an entire composite part, in particular for large-dimension composite parts and when the production rates are high and require an automated placement of the elements.

The European patent application EP1962562A1 is also known, which relates to the repair of a composite part of the engine nacelle type and describes a heating multilayer device, of the heating mat type, which has a shape defined and suited to that of the engine nacelle in order to cover a portion of this engine nacelle. The heating multilayer device comprises a thermal treatment surface adapted to the surface of the engine nacelle, this thermal treatment surface being constituted of several heating areas each comprising heating elements connected to a wire network. These heating areas may be managed independently of one another or simultaneously by a controller to locally repair a defect on the engine nacelle or one or more defect(s) affecting several areas or all of the areas covering the engine nacelle.

### SUMMARY OF THE INVENTION

The present invention relates to a mold multilayer device with an endogenous heating for making fibrous preforms of composite parts, in particular composite parts of large dimensions, for example aeronautical parts, wind turbine blades or satellite parabolas. The main objective of the invention is to ensure a homogeneous distribution of the temperature at any point of the active surface of the mold, when making fibrous preforms of the composite parts to be manufactured. This is intended to guarantee a uniform heating over the entire surface of the composite part.

According to the invention, the mold multilayer device comprises a surface layer and at least one reinforcing layer made of a composite material coated with a thermosetting material. Hence, when ready for use, the mold multilayer device has a rigid structure, unlike a flexible heating mat. The surface layer comprises a functional face of complex shape constituting a negative of a composite part to be manufactured. Furthermore, the multilayer device comprises at least one first heating network configured to heat the functional face and implement a thermal treatment surface of said composite part. Remarkably, the multilayer device comprises at least one second heating network configured to heat the surface layer around the functional face and define at least one thermal blocking belt with at least one thermal treatment surface. This at least one thermal blocking belt avoids thermal losses at the at least one periphery of the thermal treatment surface, which allows achieving a rapid stabilization of the temperatures over the entire surface of the composite part to be manufactured and covered by said thermal treatment surface.

By “surface layer”, it should be understood a stack of one or more thickness(es) of fibers, in particular in the form of a fabric and/or a multiaxial web. Said stack will be coated with a thermosetting material.

By “reinforcing layer”, it should be understood a stack of one or more thickness(es) of fibers, in particular in the form of a fabric and/or a multiaxial web. Said stack will be coated with a thermosetting material.

In the case where the surface of the composite part is solid, i.e. with no recesses, the thermal treatment surface is also solid and includes only one outer periphery, in which case one single thermal blocking belt is provided. If, on the contrary, the surface of the composite part comprises one or more recess(es), the thermal treatment surface may also comprise as many recesses or remain full. If this thermal treatment surface includes such recesses, then a thermal blocking belt will be provided at the outer periphery of the thermal treatment surface and the thermal blocking belts will be provided at inner peripheries defined by said recesses on the thermal treatment surface.

According to one embodiment of the invention, the multilayer device comprises two reinforcing layers, a first heating network and a second heating network, the first heating network and the second heating network being arranged between the two reinforcing layers.

According to one variant, the multilayer device comprises at least three reinforcing layers, two first heating networks and at least one second heating network. One amongst the first heating networks and the at least one second heating network are arranged between two reinforcing layers arranged the closest to the surface layer and the other one amongst the first heating networks is arranged between two reinforcing layers arranged the farthest from the surface layer.

In other words, according to this variant, it is proceeded with a superposition between first heating networks and, possibly, with a superposition between second heating networks. This allows increasing the thermal power per unit area compared to the solution using one single first heating network and one single second heating network. Conversely, for the same thermal power per unit area, this allows limiting the intensity of the current flowing in the first and second heating networks and consequently reducing their maximum temperature in transient conditions, which allows slowing down aging of these.

According to the multilayer device object of the invention, each first heating network comprises a first support layer, at least one first heating cord fastened on the first support layer with an arrangement defining a heating surface corresponding to the thermal treatment surface and a first wire network electrically connected to the at least one first heating cord.

By “support layer”, it should be understood a stack of one or more thickness(es) of fibers, in particular in the form of a fabric and/or a multiaxial web. Said stack will be coated with a thermosetting material.

Similarly, according to the multilayer device object of the invention, each second heating network comprises a second support layer, at least one second heating cord fastened on the second support layer with an arrangement defining the at least one thermal blocking belt at least at one periphery of the thermal treatment surface and a second wire network electrically connected to the at least one second heating cord.

Preferably, a first support layer and a second support layer consist of one single support layer on which at least one first heating cord and at least one second heating cord are fastened.

According to a preferred embodiment of the multilayer device, the first support layer and the second support layer are designed in a dry fabric, preferably a fibrous material withstanding a temperature of at least 450° C. preferably glass fiber or basalt fiber. Carbon fiber is also possible.

According to a preferred embodiment of the multilayer device, each first or second heating cord comprises an electrically-insulating core made of dry fibers, on which a resistive wire is wound. Complementarily, the assembly (the core with the wire wound thereon) may be covered with a braided sheath of insulating dry fibers over its entire length, in order to increase the level of electrical insulation of the cord. Preferably, these dry fibers consist of glass fibers or basalt fibers.

According to a preferred embodiment of the multilayer device, the at least one reinforcing layer is made of a fibrous material withstanding a temperature of at least 450° C., preferably glass fiber or basalt fiber. Carbon fibers are also possible.

According to a possible embodiment, the multilayer device comprises a metal mesh arranged between the surface layer and the at least one reinforcing layer, said metal mesh being connected to an electrical wire intended to be grounded. This allows draining the electrostatic charges that accumulate at the surface of the composite part, given the use of reinforcing layers made of an electrically-insulating material.

According to the multilayer device, each first heating network comprises at least one first temperature measurement sensor and, similarly, each second heating network comprises at least one second temperature measurement sensor. These measurement sensors allow controlling the temperatures on the thermal treatment surface and on the thermal blocking belt and regulating these from a remote control box on which the at least one first heating network and the at least one second heating network are connected. The number of first temperature measurement sensors on each first heating network will depend on the number of first heating cords in presence and on the division of the thermal treatment surface into heating areas, in order to regulate these heating areas separately. Similarly, the number of second sensors for measuring the temperature on each second heating network will depend on the number of second heating cords in presence and on the division of the thermal treatment belt into heating sections, in order to regulate these heating sections separately. According to one embodiment, these temperature measurement sensors consist of thermocouples, but variants could be considered.

According to the multilayer device, the at least one first heating network is configured so that the thermal treatment surface features a division into heating areas according to the variations in thickness and/or shape on the composite part to be manufactured. Furthermore, the at least one second heating network is configured so that the thermal blocking belt features a division into heating sections according to said heating areas and the shape of the boundary of the surface layer delimiting the functional face, so as to guarantee a homogeneous temperature on said thermal blocking belt.

According to an embodiment of the multilayer device, the division into heating sections is implemented by depositing over a second support layer as many second heating cords as heating sections in presence on the blocking belt so as to individually regulate the powers of these second heating cords, in order to obtain a homogeneous temperature on the thermal blocking belt. According to a first variant, the at least one second heating network comprises one single second heating cord fastened on a second support layer, the division of the thermal blocking belt into heating sections being implemented by depositing said second heating cord over the second support layer with a variable step. According to a second variant, the at least one second heating network comprises one single second heating cord fastened on a second support layer, the division of the thermal blocking belt into heating sections being implemented using a second heating cord configured to have a variable linear ohmic value over its length. These first and second variants have the advantage of reducing to one the number of second heating cords, which allows reducing the number of sensors for measuring the temperature and the bulk of the second wire network electrically connected to the second heating cord and to the temperature measurement sensors.

The same features could be implemented on the thermal treatment surface. Thus, the division of the thermal treatment surface into heating areas is implemented by depositing over a first support layer as many first heating cords as heating areas in presence on said thermal treatment surface, so as to individually regulate the powers of these first heating cords, in order to obtain a homogeneous temperature on the thermal treatment surface. According to a first variant, the at least one first heating network comprises one single first heating cord fastened on a first support layer, the division of the thermal treatment surface into heating areas being implemented by depositing said first heating cord over the first support layer with a variable step. According to a second variant, the at least one first heating network comprises one single first heating cord fastened on a first support layer, the division of the thermal treatment surface into heating sections being implemented using a first heating cord configured to have a variable linear ohmic value over its length.

According to the invention, the thermosetting material may be of an organic origin, for example Cyanate-Ester resin, Phthalonitrile resin, Epoxy resin, or other resins, or of a non-organic origin, for example ceramic, ceramic cements or ceramic adhesives, or other non-organic materials. According to a preferred embodiment of the multilayer device, the thermosetting material is configured to withstand temperatures of at least 400° C. Preferably, this thermosetting material is selected from among Cyanate-Ester resin, Phthalonitrile resin and ceramic. The use of such a thermosetting material, combined with the use of the glass fiber, of the carbon fiber or of the basalt fiber to make the support layers, the reinforcing layers and the heating cords, allows designing a mold for manufacturing a composite part whose multilayer device is capable of rising to temperatures in the range of 450° C. The ability to exceed the temperature of 200° C. (current limit of composite tooling) allows addressing the high demand for consolidation operations (for example) on composite parts with a thermoplastic matrix (such as polyamide, PEAK), which require thermal treatment temperatures exceeding 200° C. and which could reach 390° C. For molds equipped with said multilayer device working at temperatures lower than 200° C. the thermosetting material could be an epoxy resin, for example.

The invention also relates to a mold for manufacturing composite parts which comprises a multilayer device having either one of the aforementioned features.

### BRIEF DESCRIPTION OF THE FIGURES

The features and advantages of the invention will become apparent upon reading the following description based on figures, wherein:

FIG. 1 schematically shows an assembly of two molds for making fiber preforms of composite parts;

FIG. 2 schematically shows a first embodiment of a mold multilayer device embedding an endogenous heating system;

FIG. 3 schematically shows a second embodiment of a mold multilayer device embedding an endogenous heating system;

FIG. 4 schematically shows a third embodiment of a mold multilayer device embedding an endogenous heating system;

FIG. 5 schematically shows a first embodiment of a heating cord that can be implemented on a first or second heating network;

FIG. 6 schematically shows a second embodiment of a heating cord that can be used on a first or second heating cord;

FIG. 7 schematically shows a parallel connection of two heating cords on a first or second heating network;

FIG. 8 schematically shows a first example of the arrangement of a thermal treatment surface and of a thermal blocking belt on the multilayer device;

FIG. 9 schematically shows a second example of the arrangement of a thermal treatment surface and of a thermal blocking belt on the multilayer device;

FIG. 10 schematically shows a third example of the arrangement of a thermal treatment surface and of a thermal blocking belt on the multilayer device;

FIG. 11 schematically shows a fourth example of the arrangement of a thermal treatment surface and of two thermal blocking belts on the multilayer device;

FIG. 12 schematically shows a first example of the arrangement of a heating cord on a thermal treatment surface or on a thermal blocking belt;

FIG. 13 schematically shows a second example of the arrangement of a heating cord on a thermal treatment surface or on a thermal blocking belt;

FIG. 14 schematically shows a third example of the arrangement of a heating cord on a thermal treatment surface or on a thermal blocking belt;

FIG. 15 schematically shows a fourth example of the arrangement of two heating cords on a thermal treatment surface or on a thermal blocking belt;

FIG. 16 schematically shows a fifth example of the arrangement of a heating cord on a thermal treatment surface or on a thermal blocking belt;

FIG. 17 schematically shows a sixth example of the arrangement of a heating cord on a thermal treatment surface or on a thermal blocking belt;

FIG. 18 schematically shows a seventh example of the arrangement of a heating cord on a thermal treatment surface or on a thermal blocking belt;

FIG. 19 schematically shows a fifth example of the arrangement of a thermal treatment surface and of a thermal blocking belt on the multilayer device;

FIG. 20 schematically shows a sixth example of the arrangement of a thermal treatment surface and of a thermal blocking belt on the multilayer device;

FIG. 21 schematically shows a first example of a functional face and of a boundary of a surface layer of a multilayer device and shows an example of implantation of the thermal treatment surface and of the thermal treatment belt;

FIG. 22 schematically shows a second example of a functional face and of a boundary of a surface layer of a multilayer device and shows an example of implantation of the thermal treatment surface and of the thermal treatment belt;

FIG. 23 schematically shows a functional face and a boundary of a surface layer of a multilayer device similar to that of FIG. 2 and shows an implantation of a thermal treatment belt consisting of one single heating cord.

### DETAILED DESCRIPTION

In the following description, the same references are used to designate the same features or their equivalents according to the different variants, unless indicated otherwise in the text.

Furthermore, the terms high, low, upper and lower which might be used in the description will be used while considering the normal position of the multilayer device placed on a horizontal plane.

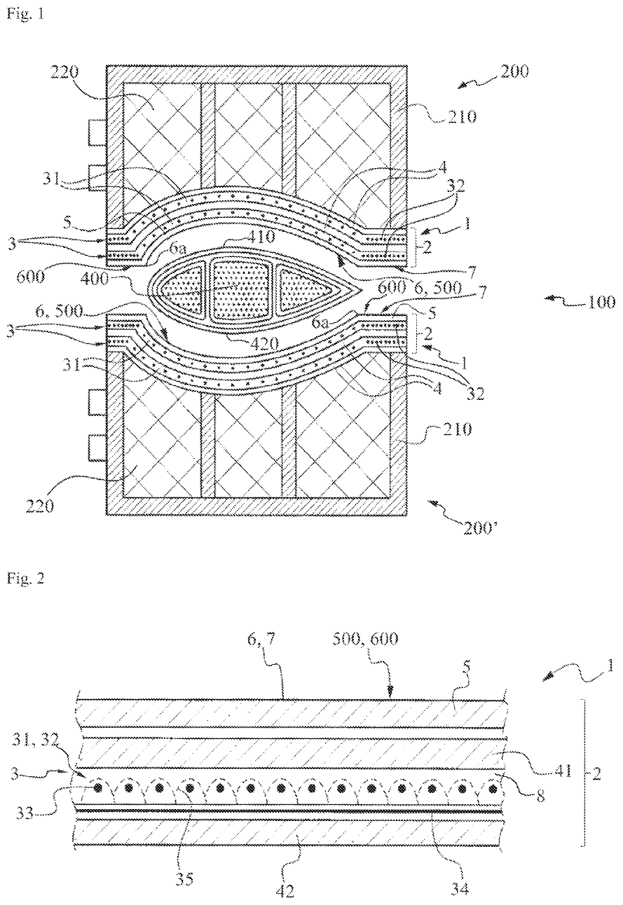

FIG. 1 shows an assembly 100 of an upper mold 200 and of a lower mold 200′ which are arranged opposite each other and have an identical or similar design. This assembly 100 is configured to design a molded part 400 made of composite materials by an infusion, RTM or any other process type, this molded part 400 featuring for example an aircraft wing profile, as illustrated in FIG. 1. Of course, other composite parts with large dimensions or with small dimensions could be manufactured based on the same principle.

This upper mold 200 and this lower mold 200′ could also be used individually for making parts made of composite materials by infusion or any other process.

Next, the term mold is used to indifferently designate the upper mold 200 or the lower mold 200′, the same references being used to describe the features of said molds.

The mold 200, 200′ comprises a multilayer device 1 constituting a main element of the latter, said multilayer device 1 being described in detail hereafter according to several possible variants. The mold 200, 200′ comprises a stiffening box 210 in which a heat-insulating material 220 is integrated. The stiffening box 210 receives the multilayer device 1, as illustrated in FIG. 1.

As shown in FIG. 1, the multilayer device 1 includes a multilayer structure 2 which embeds an endogenous heating system 3, reinforcing layers 4 and a surface layer 5 implementing a functional face 6 and a boundary 7, the functional face 6 constituting the negative of the upper face 410 or of the lower face 420 of the composite part 300 to be manufactured. In this FIG. 1, the endogenous heating system 3 is composed of first heating networks 31 which allow constituting a thermal treatment surface 500 over the entire functional face 6. In this FIG. 1, the endogenous heating system 3 is also composed of second heating networks 32 which allow constituting a thermal blocking belt 600 around the periphery 6a of the functional face 6, over at least one portion of the boundary 7.

The composition of the multilayer structure 2 may differ from that of FIG. 1, in particular the design of the endogenous heating system 3 and the number of reinforcing layers 4, without modifying the final purpose consisting in implementing the thermal treatment surface 500 over the entire functional face 6 and the thermal blocking belt 600 around the periphery 6a of the functional face 6. FIGS. 2 to 4 show three variants of implementation of the multilayer structure 2. In these FIGS. 2 to 4, there are illustrated only portions of the multilayer structure 2, which may correspond either to portions located on the functional face 6 and implementing the thermal treatment surface 500, or to portions located on the boundary 7 and implementing the thermal blocking belt 600; the references therefore appear in the figures to illustrate these two cases.

In FIG. 2, the multilayer structure 1 comprises a stack of layers with a surface layer 5 featuring the functional face 6 or the boundary 7. This surface layer 5 is made of a composite material and it could possibly be coated with a “gelcoat” to improve its surface condition, preferably used for small or medium series. In one variant, for manufacturing parts in large or very large series, it could also be possible to provide for a surface layer 5 made of metal, as described in patent FR3055570B1.

In this FIG. 2, the multilayer structure 2 comprises a first reinforcing layer 41 and a second reinforcing layer 42 made of a composite material with an organic matrix or with a thermosetting non-organic matrix, for example a Cyanate-Ester resin, a Phthalonitrile resin or an Epoxy resin for the thermosetting organic matrix or a ceramic for the thermosetting non-organic matrix, and a stack of one or more thickness(es) of glass, basalt or carbon fibers. Between these two reinforcing layers 41, 42 is embedded either a first heating network 31 when implementing the thermal treatment surface 500, or a second heating network 32 when implementing the thermal blocking belt 600. This first heating network 31 and this second heating network 32 are of the resistive type, manufactured by means of heating cords 33 preferably such as that one described in patent FR2956555B1.

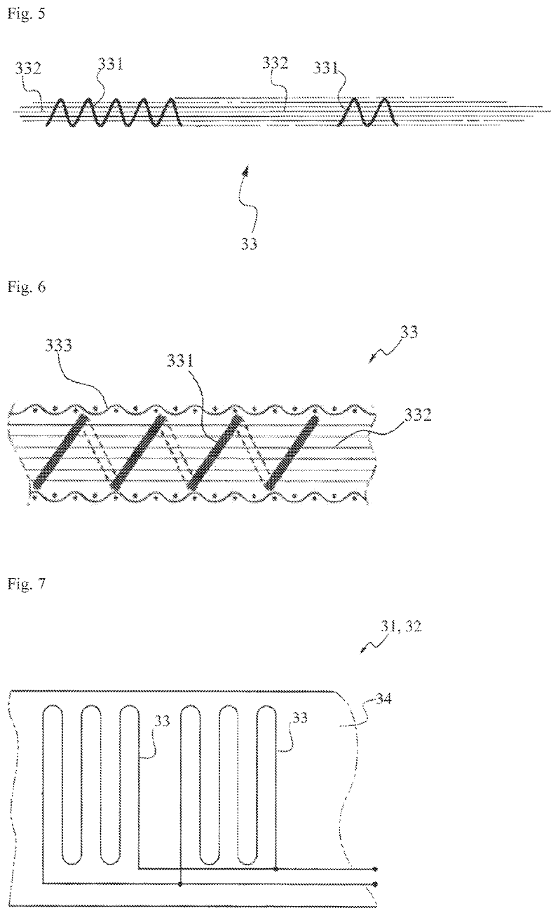

As illustrated with reference to FIGS. 2 and 5, a first heating network 31 or a second heating network 32 comprises at least one heating cord 33 which includes a resistive wire 331 surrounding an electrically-insulated core 332, this core 332 being constituted by dry fibers formed as a wick. The resistive wire 331 is electrically connected by means of a connection cable to a regulation box 57 illustrated in FIG. 8. The core 332 constitutes a support for an impregnation material 8 which allows ensuring the adhesion of the heating cord 33 with the reinforcing layers 41, 42 which are, in turn, coated with this impregnation material 8. In other words, when the mold 200, 200′ is operational, the organic or non-organic matrix of the composite of the multilayer structure 2 has impregnated this core 332, which then forms on its own a structural portion of said multilayer structure 2. The heating cord 33 may possibly further include a dry fiber sheath 333 surrounding said resistive wire 331, as illustrated in the variant of FIG. 6, and able to be impregnated with the impregnation material 8. This sheath 333 is also impregnated with the organic or non-organic matrix of the composite of the multilayer structure 2 and then also forms on its own a structural portion of said multilayer structure. The choice of integrating this sheath 333, or not, will depend in particular on the electrical conductivity of the reinforcing layers 41, 42, depending on the composite material used for these. This sheath 333 may result from wrapping, braiding or knitting. The heating cord 33 is affixed to a support layer 34 consisting of a dry fabric, by sewing 35. Advantageously, this dry fabric is made of a fibrous composite material identical to that used for the reinforcing layers 41, 42. For example, depending on the considered implementation, the dry fabric will be made of glass fibers, carbon fibers, basalt fibers or thermoplastic fibers. The seams 35 of the heating cords 33 on the support layer 34 are made according to a pattern so that the location of the first heating network 31 and of the second heating network 32 on said support layer 34 is accurate and ensures a controlled thermal distribution at the thermal treatment surface 500 and the thermal blocking belt 600, in accordance with determined specifications for each composite part 400 to be manufactured. Advantageously, the seams 35 will be made automatically by means of a numerically-controlled sewing machine or embroidery machine.

In the variant of FIG. 3, the multilayer structure 2 comprises all of the features of FIG. 2 to which reference may be made by incorporation of the references. The multilayer structure 2 further comprises a metal mesh 9 also embedded in the impregnation material 8. This metal mesh 9 allows draining the electrostatic charges that accumulate at the surface of the multilayer structure 2, given the use of reinforcing layers 41, 42 made of insulating composite material. In order to enable the dissipation of these charges, it is provided to connect the metal mesh 13 to the earth by means of a cable (not illustrated).

In the aforementioned variant where the surface layer 5 consists of a metal skin as a replacement for a layer made of a composite material, said metal skin advantageously allows eliminating the static charges and, thus, avoiding the need for using a metal mesh 9 such as that one provided for in the embodiment of FIG. 3.

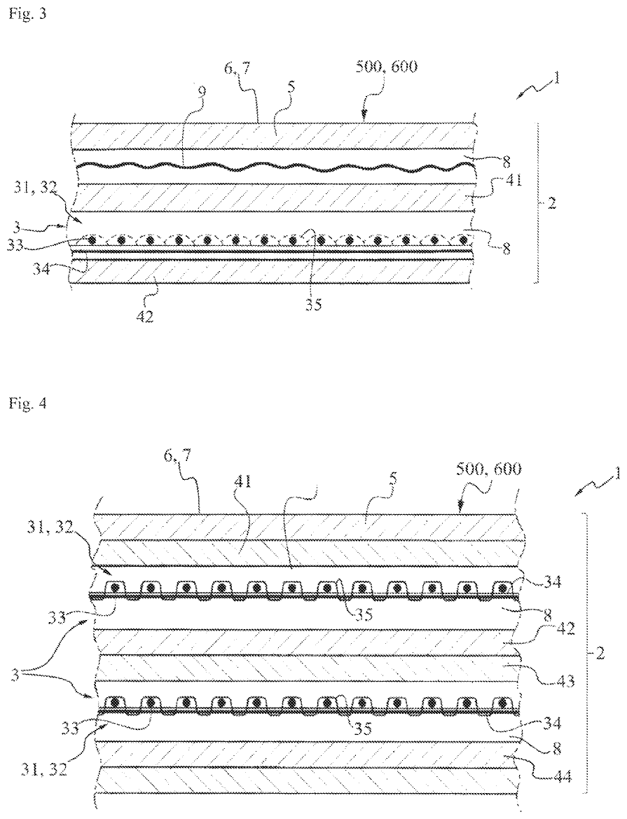

In the variant of FIG. 4, the multilayer structure 2 of the multilayer device 1 comprises an endogenous heating system 3 with two first heating networks 31 on two levels, for the implementation of the thermal treatment surface 500, or with two second heating networks 32 on two levels, for the implementation of the thermal blocking belt 600. One amongst the first heating networks 31 and one amongst the second heating networks 32 are placed between two first reinforcing layers 41, 42. The other one amongst the first heating networks 31 and the other one amongst the second heating networks 32 are placed between two second reinforcing layers 43, 44. The design of the two first heating networks 31 and of the two second heating networks 32 is identical to the previous ones in FIGS. 2 and 3, each of the first heating networks 31 and of the second heating networks 32 may include one or more heating cord(s) 33 depending on the shape of the composite part 400 to be manufactured, as will be set out throughout examples in the following description. The implantation of two first heating networks 31 and of two second heating networks 32 has different advantages. In particular, it allows increasing the thermal power per unit area compared to the solution using one single first heating network 31 and one single second heating network 32. Furthermore, for the same thermal power per unit area, it allows limiting the intensity of the current flowing in the heating cords 33 and consequently reducing their temperature, thereby allowing slowing down aging of the impregnation material 8 in the vicinity of the heating cords 33. This solution using several first and second heating networks 31, 32 at different levels of the multilayer device I also allows reducing the temperature gradients and therefore limiting the thermal forces experienced by the multilayer structure 2 of said composite device 1.

Other variants of implementation of the multilayer structure 2 may be considered based on the principle of the variants described with reference to FIGS. 1 to 4. For example, it would be possible to provide for two first heating networks 31 on two levels, as in FIG. 4, for the implementation of the thermal treatment surface 500 and, one single second heating network 32 on one level, as in FIG. 2, for the implementation of the thermal blocking belt 600. Moreover, it is also possible to consider other equivalent or non-equivalent endogenous heating systems 3, embedded within this multilayer structure 2 for the implementation of the thermal treatment surface 500 and of the thermal blocking belt 600.

The impregnation material 8 may originate from a non-organic thermosetting origin, preferably ceramic, or from a thermosetting organic origin, preferably selected from among Cyanate-Ester resin and Phthalonitrile resin. The use of such a thermosetting material, combined with the use of glass fibers, carbon fibers, thermoplastic fibers or basalt fibers for making the support layers 34, the reinforcing layers 41, 42, 43, 44 and the heating cords 33, allows designing a mold 200, 200′ for the manufacture of a composite part, the multilayer device 1 of which is capable of rising to temperatures in the range of 450° C. and at least higher than 400° C. For molds 200, 200′ working at temperatures that do not exceed 200° C., the thermal blocking belt 500 preservers all of its interest, but epoxy type thermosetting resins could be used instead of a Cyanate-Ester or Phthalonitrile resin or ceramic.

The first heating network 31 and/or the second heating network 32 may include one or more heating cord(s) 33, as mentioned before. As illustrated in FIG. 7, in the presence of two or more heating cord(s) 33, these could be connected to one another in series or in parallel, combinations of heating cords 33 connected in series and others connected in parallel being possible. This allows having a better control of the heating power supplied at any point in order to obtain the desired temperature(s) all over the thermal treatment surface 500 and all over the thermal blocking belt(s) 600, with a reduced number of first and second heating cords 33.

Referring to FIGS. 8 to 20, the multilayer device 1 comprises one or more first heating networks 31 implementing a thermal treatment surface 500 whose shapes and dimensions depend on and correspond to the functional face 6 constituting the negative of the surface of the composite part 400 to be manufactured. Each first heating network 31 consists of one or more first heating cord(s) 33 which are preferably arranged in a serpentine or spiral fashion. The number and arrangement of first heating cords 33 will depend on the different thicknesses existing over the composite part 400 and their shapes and, consequently, of the need to heat said composite part 400 differently according to these thicknesses.

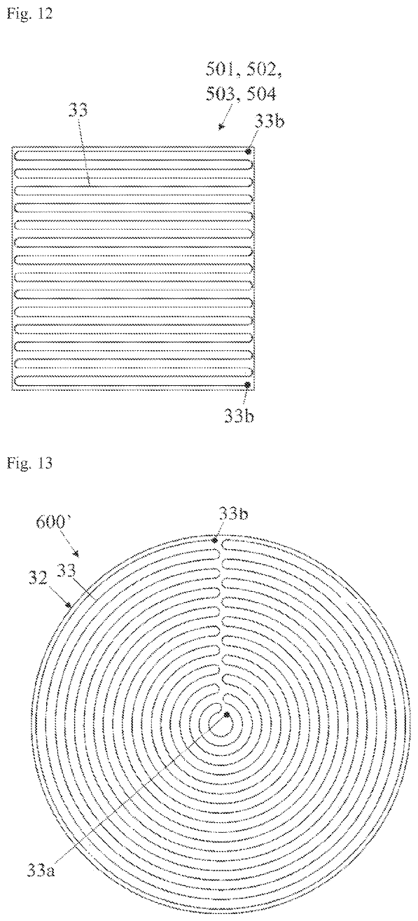

In the example of FIG. 8, the thermal treatment surface 500 is formed of one single rectangular portion 501. The first heating network 31 could consist of one single first heating cord 33 arranged in a serpentine fashion all over this portion 501, as illustrated in FIG. 12. It could be considered to arrange this first heating cord 33 in a spiral fashion all over this portion 501, and possibly according to other arrangements.

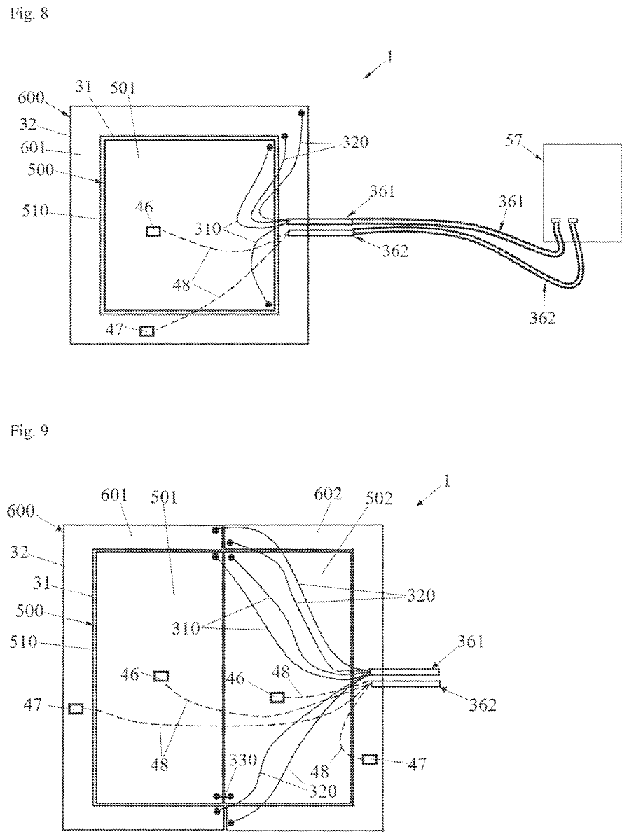

In the example of FIG. 9, the thermal treatment surface 500 is rectangular and formed of two rectangular portions 501, 502, on which a first heating network 31 is defined which includes two first heating cords 33 arranged in a serpentine fashion respectively on the two portions 501, 502, as shown in FIG. 12. These two portions 501, 502 can heat independently of one another, according to the thicknesses on the composite part 400. It could be considered to arrange these first heating cords 33 in a spiral fashion on these two portions 501, 502, and possibly according to other arrangements.

In the example of FIG. 10, the thermal treatment surface 500 is rectangular and formed of four rectangular portions 501, 502, 503, 504, on which a first heating network 31 is defined which comprises four first heating cords 33 arranged in a serpentine fashion respectively on the portions 501, 502, 503, 504, as shown in FIG. 12. These four portions 501, 502, 503, 504 can heat independently of one another, according to the thicknesses on the composite part 400. It could be considered to arrange these first heating cords 33 in a spiral fashion on these four portions 501, 502, 503, 504, and possibly according to other arrangements.

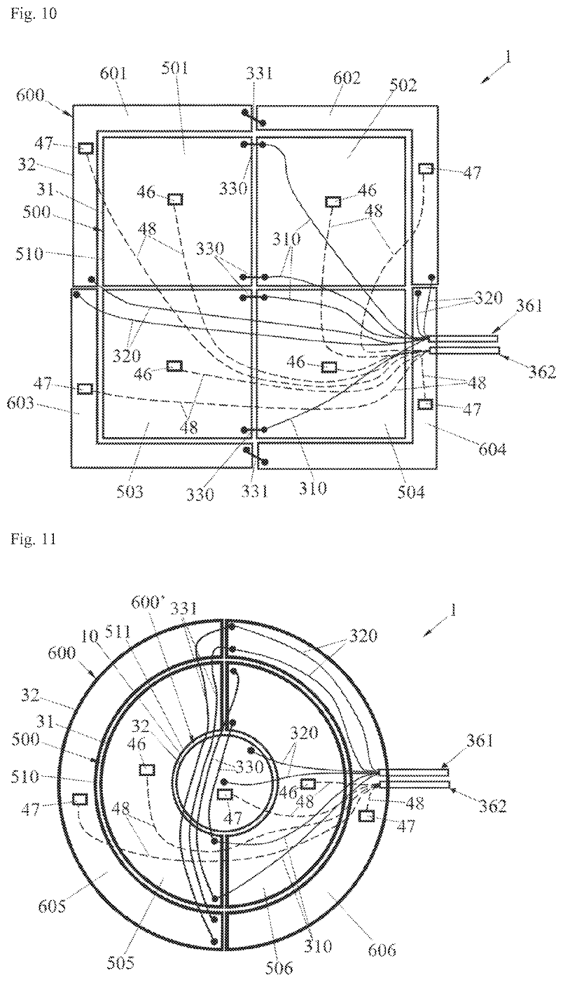

In the example of FIG. 11, the thermal treatment surface 500 is a ring formed of two arcuate portions 505, 506 on which a first heating network 31 is defined, the first heating network 31 including two first heating cords 33 arranged in a serpentine fashion respectively on the portions 505, 506, as shown in FIG. 14. These two portions 505, 506 can heat independently of one another, according to the thicknesses on the composite part 400. In this FIG. 14, only one arc portion is illustrated, but the principle remains identical by increasing the angle of this arc portion over a semicircle, like for the two portions 505, 506. It could be considered to arrange these first heating cords 33 in a spiral fashion on these two portions 505, 506, and possibly according to other arrangements.

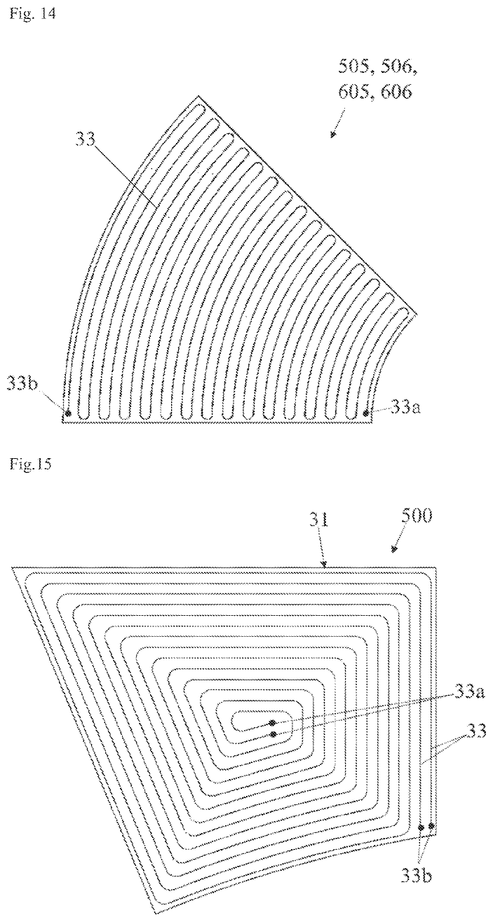

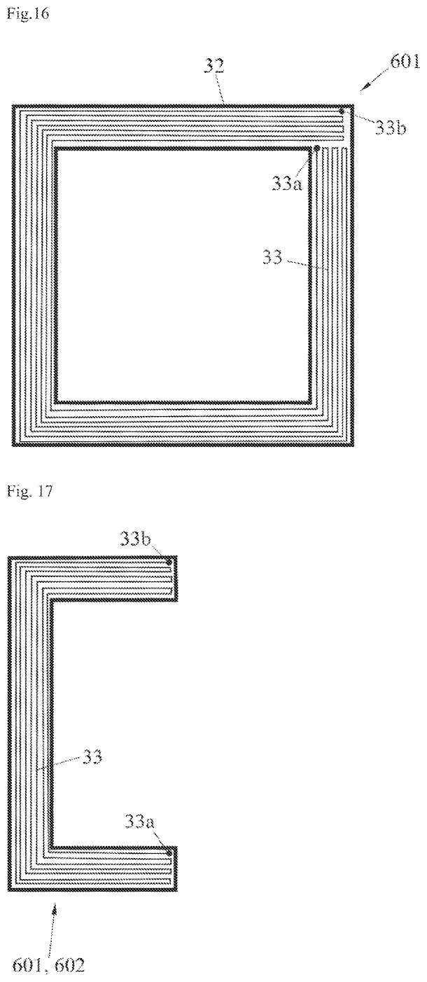

Of course, other various and varied shapes of portions of the thermal treatment surface 500 could be envisaged on the same principle, depending on the shape and the thicknesses on the composite part 400, like any polygonal shape on which two first heating cords 33 constituting a first heating network 31, as illustrated in FIG. 15, would be arranged in a spiral fashion. It could be considered to arrange these first heating cords 33 in a serpentine fashion on this polygonal shape, and possibly according to other arrangements. Of course, one, two or more heating cord(s) 33 could be arranged according to the same principle as in FIG. 15 to implement the first heating network 31 on said thermal treatment surface 500, and possibly a second heating network 32 on the thermal blocking belt 600, as will be described hereinafter. This could also be considered with other shapes than that of FIG. 15. This arrangement of several heating cords 33, for example in serpentine or spiral fashion, next to each other, allows adapting the heating powers of the thermal treatment surface in order to obtain a homogeneous temperature regardless of the variations in the thicknesses of the composite part to be preformed or to be consolidated and, also, adapting the heating powers on the blocking belt to ensure homogeneity of temperatures at the boundary of said thermal treatment surface.

Referring to FIGS. 8 to 20, the multilayer device 1 comprises one or more thermal blocking belt(s) 600, 600′, depending on whether the thermal treatment surface 500 is solid, like in FIGS. 8 to 10, or has a recess 10, like in FIG. 11, the thermal blocking belt 600 avoids thermal losses on the side of the outer periphery 510 of the thermal treatment surface 500 and, in the case of FIG. 11, a second thermal blocking belt 600′ avoids thermal losses on the side of the inner periphery 511 of the thermal treatment surface 500, which allows obtaining homogeneity of the temperatures over the entire surface of the composite part 400 to be manufactured and covered by said thermal treatment surface 500.

In the example of FIG. 8, the thermal blocking belt 600 is formed of a rectangular frame in one single portion 601 arranged at the outer periphery 510 of the thermal treatment surface 500 and consisting of a second heating network 32 which includes a second heating cord 33 arranged in a serpentine fashion, as shown in FIG. 16. It could be considered to arrange this second heating cord 33 in a spiral fashion on this frame 32, and possibly according to other arrangements.

In the example of FIG. 9, the thermal blocking belt 600 is formed of a rectangular frame in two U-shaped portions 601, 602 arranged at the outer periphery 510 of the thermal treatment surface 500 and consisting of a second heating network 32 which includes two second heating cords 33 arranged in a serpentine fashion, one for each frame portion 601, 602, as shown in FIG. 17. These two frame portions 601, 602 respectively fit in the two portions 501, 502 of the thermal treatment surface 500, as shown in FIG. 9. It could be considered to arrange the second heating cords 33 in a spiral fashion on these two portions 601, 602 of the thermal blocking belt 600, and possibly according to other arrangements.

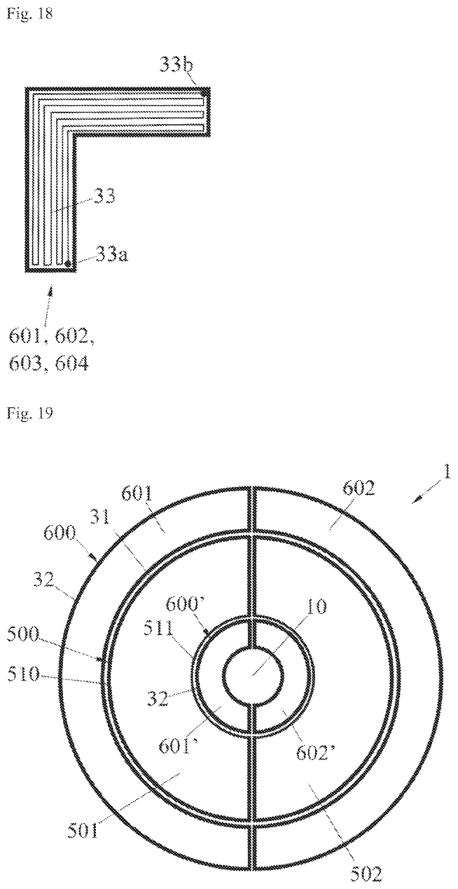

In the example of FIG. 10, the thermal blocking belt 600 is formed of a rectangular frame in four bracket-like shaped portions 601, 602, 603, 604 arranged at the outer periphery 510 of the thermal treatment surface 500 and consisting of a second heating network 32 which includes four second heating cords 33 arranged in a serpentine fashion, one for each frame portion 601, 602, 603, 604, as shown in FIG. 18. These four frame portions 601, 602, 603, 604 respectively fit in the four portions 501, 502, 503, 504 of the thermal treatment surface 500, as shown in FIG. 10. It could be considered to arrange these second heating cords 33 in a spiral fashion on these four portions 501, 502, 503, 504 of the frame 32, and possibly according to other arrangements.

In the example of FIG. 11, a first thermal blocking belt 600 is formed of a circular frame in two portions 605, 606 in the form of an arc arranged at the circular outer periphery 510 of the thermal treatment surface 500 and consisting of a second heating network 32 which includes two second heating cords 33 arranged in a serpentine fashion, one for each arcuate portion 605, 606, as shown in FIG. 14. In this FIG. 14, only one arc portion is illustrated, but the principle remains identical by increasing the angle of this arc portion over a semicircle, like for the two portions 605, 606. It could be considered to arrange these second heating cords 33 in a spiral fashion on these two portions 605, 606 of the circular frame 32, and possibly according to other arrangements.

Furthermore, in this FIG. 11, a second thermal blocking belt 600′ is formed of a disc arranged in the recess 10, around the inner periphery 511 of the thermal treatment surface 500, this disc being constituted of another second heating network 32 which includes a second heating cord 33 arranged in a serpentine fashion, as shown in FIG. 13. It could be considered to arrange this second heating cord 33 in a spiral fashion on this disc 34, and possibly according to other arrangements. This disc constituting the second thermal blocking belt 600′ may also be replaced by two half-rings 601′, 602′, for example, as illustrated by the variant of FIG. 19 which replicates the other features of the variant of FIG. 11. In this case, the second heating network 32 will include two second heating cords 33 implemented based on the principle of FIG. 14.

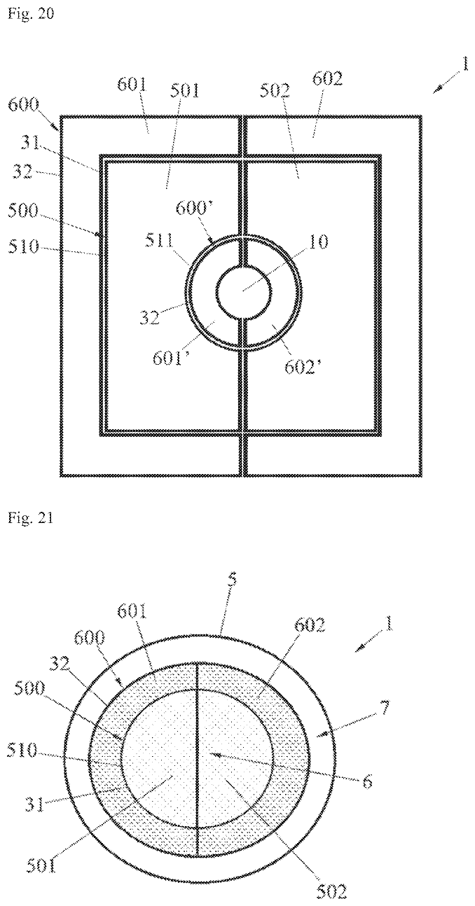

The variant of the multilayer device 1 of FIG. 20 is a combination of FIG. 9 and of FIG. 19. The thermal treatment surface 500 is made into two portions 501, 502, like in FIG. 9, and comprises an outer peripheral edge 510 with a rectangular shape and an inner peripheral edge 511 with a circular shape. A first thermal belt 600 is constituted of a frame made into two portions 601, 602 which respectively fit on the two portions 501, 502 of the thermal treatment surface 500 to come around the outer peripheral edge 510, like in FIG. 9. The second thermal blocking belt 600 is constituted of two half-rings 601′, 602′ placed in the recess 10 to come around the inner peripheral edge 511 of the thermal treatment surface 500, like in FIG. 19.

Thus, it should be understood that FIGS. 8 to 20 illustrate only a few possible and non-limiting examples of shapes that could be implemented in the composition of a thermal treatment surface 500 or a thermal blocking belt 600, 600′. In these FIGS. 8 to 20, the thermal treatment surfaces 500 and the thermal blocking belts 600, 600′ are illustrated flat; in reality, these could be installed on multilayer devices 1 according to the invention, having non-developable complex surfaces, for example.

As illustrated in FIGS. 8 to 11 and mentioned before with reference to FIG. 7, the first heating networks 31 comprise a first wire network 310 which powers the first heating cords 33 on the treatment surface 500. Similarly, the second heating networks 32 comprise a second wire network 320 which powers the second heating cords 33 on the thermal blocking belt 600 and on the second thermal blocking belt 600′, if the latter is present, as is the case in FIG. 11. The first wire network 310 and the second wire network 320 are joined within the same electric power supply cable 361.

In the case where several first heating cords 33 are present on the thermal treatment surface 500, these can be connected in series and/or in parallel by means of first electrical connection wires 330, In order to have a better control of the heating power. These first heating cords 33 may be temperature-regulated in a related manner or separately, that being so in order to guarantee thermal homogeneity over the entire thermal treatment surface 500. Similarly, in the case where several second heating cords 33 are present on the thermal blocking belt(s) 600, 600′, these may be connected in series and/or in parallel by means of second electrical connection wires 331, in order to have a better control of the heating power. These second heating cords 33 may be temperature-regulated in a related manner or separately, in order to guarantee thermal homogeneity over the entire thermal blocking belt 600′. The implantation of several first heating cords 33 and of several second heating cords 33 on the same first support layer 34 has the advantage of better controlling the heating power supplied at any point in order to obtain the desired temperature(s) at any point of the thermal treatment surface 500 and at any point of the thermal blocking belt(s) 600, 600′, with a reduced number of first and second heating cords 33.

As an illustrative and non-limiting example, in the example of FIG. 9, the two portions 501, 502 of the thermal treatment surface 500 are connected in series by first electrical connection wires 330. In the example of FIG. 10, the two first portions 501, 502 of the thermal treatment surface 500 are connected in parallel by first electrical connection wires 330, the same applies for the two second portions 503, 504 of said thermal treatment surface 500, and the two first portions 601, 602 of the thermal blocking belt 600 are connected in series by second electrical connection wires 331, the same applies for the two second portions 603, 604 of the thermal blocking belt 600. In the example of FIG. 11, the two arcuate portions 505, 506 of the thermal treatment surface 500 are connected in series by first electrical connection wires 330 and the two arcuate portions 605, 606 of the thermal blocking belt 600 are connected in series by second electrical connection wires 331.

The first wire network 310, the second wire network 320, the first electrical connection wires 330 and the second electrical connection wires 331 are connected by welding or by mechanical assembly by crimping with one of the ends 33a, 33b of a first or second heating cord 33.

Referring to FIGS. 8 to 11, first thermocouples 46 are arranged on the different portions 501, 502, 503, 504, 505, 506 of the thermal treatment surface 500, so as to raise the temperatures of these. Similarly, second thermocouples 47 are arranged on the different portions 601, 602, 603, 604, 605, 606 of the thermal blocking belt 600 and on the second thermal blocking belt 600′ in the case of FIG. 11, so as to raise the temperatures of these. A temperature measurement cable 362 has electrical connection wires 48 which are connected to these thermocouples 46, 47 by welding.

The electric power supply cable 361 of the first and second heating cords 33 and the temperature measurement cable 362 are connected upstream to a regulation box 57, illustrated in FIG. 8, which collects the measurements of the temperatures at the thermal treatment surface 500 and at the thermal blocking belt(s) 600, 600′ to adjust the electric power supplies of the first and second heating cords 33. This enables an accurate control of the thermal treatment of the composite part 400.

The thermal blocking belt 600 should ensure a stable and homogeneous temperature around the thermal treatment surface 500 allowing heating the composite part 400 during manufacture thereof. Depending on the heat exchanges with its environment, this thermal blocking belt 600 should provide more or less power; if the environment more or less favors exchanges, the thermal blocking belt 600 should supply more or less heat to remain at the same temperature in the vicinity of the thermal treatment surface 500. A thermal blocking belt 600 of the single heating area type with a constant surface power, i.e. having one single heating network with constant characteristics (constant step, constant ohmic value of the heating cord 33, one single thermocouple 47 and one single regulation area) cannot be enough, except in very particular cases of homogeneous environment and of homogeneous single-area functional face 6. In most cases, it will be necessary to adapt the thermal blocking belt 600 to its environment.

FIG. 21 shows a first case of a functional face 6 on which the thermal treatment surface 500 comprises two portions 501, 502, a first heating network 31 comprising two heating cords 33 regulated separately and implementing two different heating areas defining said two portions 501, 502. In this FIG. 21, the boundary 7 constituting the external environment of the functional face 6 is homogeneous, thereby enabling the implementation of a thermal blocking belt 600 in two portions 601, 602, a second heating network 32 comprising two heating cords 33 regulated separately and implementing two different heating sections defining said two portions 601, 602 placed in correspondence with the two portions 501, 502 of the thermal treatment surface 500.

FIG. 22 shows a second case of a functional face 6 over which the thermal treatment surface 500 comprises three portions 501, 502, 503, a first heating network 31 comprising three heating cords 33 regulated separately and implementing three different heating areas defining said three portions 501, 502, 503. In this FIG. 22, the boundary 7 constituting the external environment of the functional face 6 is not homogeneous, since said boundary 7 has a larger exchange surface at the angles than on the sides. For this purpose, the thermal blocking belt 600 is provided with a greater division into heating sections in order to have a better thermal compensation resolution at the periphery of the functional face 6 where said belt is located. To this end, in FIG. 22, the second heating network 32 comprises eleven heating cords 33 regulated separately and implementing eleven different heating sections defining eleven portions 601 to 611. Four heating sections consisting of the portions 601, 603, 606, 609 located in the angular portions of the functional face 6 and of the boundary 7, have to compensate for greater thermal losses than the seven other heating sections consisting of the portions 602, 604, 605, 607, 608, 610, 611, because of the larger surfaces at the four angular portions of the boundary 7. The three heating sections consisting of the portions 611, 602, 604 associated with the two heating sections consisting of the portions 601, 603, are juxtaposed with the contour of the third portion 503 of the thermal treatment surface 500. The two heating sections consisting of the portions 605, 607 associated with the heating section consisting of the portion 606, are juxtaposed with the contour of the second portion 502 of the thermal treatment surface 500. The two heating sections consisting of the portions 608, 610 associated with the heating section consisting of the portion 609, are juxtaposed with the contour of the first portion 501 of the thermal treatment surface 500.

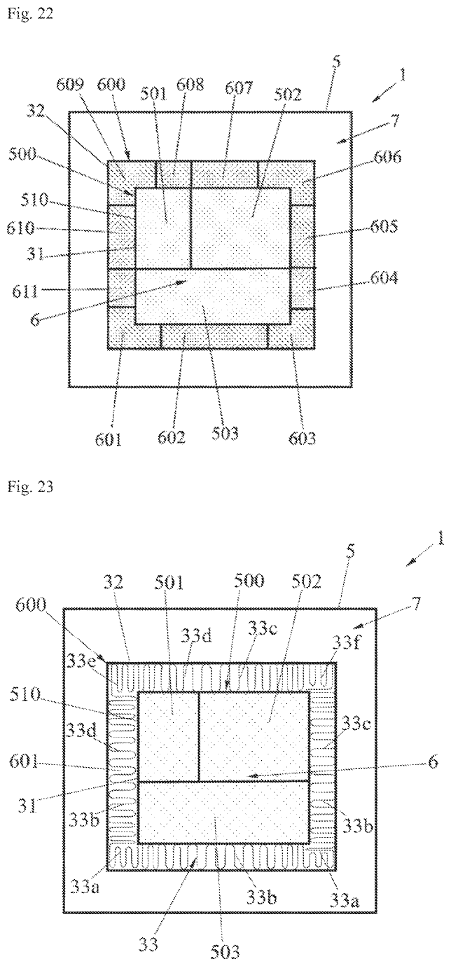

FIG. 23 shows a situation similar to that of FIG. 22 where the larger surfaces in the four angular portions of the boundary 7 generate greater thermal losses that should be compensated for differently from the other portions of the boundary 7. The previously-described examples of FIGS. 8 to 11 and 22 show that a division of the thermal treatment surface 500 into heating areas and of the thermal blocking belt(s) 600, 600′ into heating sections generates the presence of a large number of thermocouples 46, 47 as well as a bulk of wires for connecting the heating cords 33 and the thermocouples 46, 47 to the regulation box 57. According to FIG. 23, the functional face 6 has a thermal treatment surface 500 which comprises three portions 501, 502, 503, a first heating network 31 comprising three heating cords 33 regulated separately and implementing three different heating areas defining said three portions 501, 502, 503. In this FIG. 23, the second heating network 32 implementing the thermal blocking belt 600 comprises one single heating cord 33 which is deposited over the support layer 34 with a variable step, as shown in FIG. 23. The two sections 33a of the heating cord 33 are located in the angular portions of the functional face 6 and of the boundary 7, at the third portion 503 of the thermal treatment surface 500, the portion 33e of the heating cord 33 is located in the portion of the functional face 6 and of the boundary 7, at the first portion 501 of the thermal treatment surface 500. The section 33f of the heating cord 33 is located in the angular portion of the functional face 6 and of the boundary 7, at the second portion 502 of the thermal treatment surface 500. These four sections 33a, 33e, 33f should compensate for greater thermal losses than the other sections 33b, 33c, 33d of the heating cord 33, because of the larger surfaces in the four angular portions of the boundary 7. For this purpose, these sections 33a, 33e, 33f have a narrow step, the step varying according to the sections 3a, 3d, 3c, 3d, 3e, 3f and their positions around the thermal treatment surface 500, as illustrated in FIG. 23. The three sections 33b of the heating cord 33 are contiguous with the contour of the third portion 503 of the thermal treatment surface 500. The two sections 33c of the heating cord 33 are contiguous with the contour of the second portion 502 of the thermal treatment surface 500. The two sections 3 d of the heating cord 33 are contiguous with the contour of the first portion 501 of the thermal treatment surface 500. Alternatively, it is possible to replace this variation in the step of the heating cord 33 by using a heating cord having variable linear ohmic values over its length.

Other variants of the multilayer device I may be considered without departing from the scope of the invention. For example, it would be possible to provide at the back of the multilayer structure 2, i.e. on the side opposite to that including the surface layer 5 with the functional face 6, a sandwich structure embedding a heat exchanger such as that described in patent FR3055571B1.

1. A multilayer device for a mold comprising:
a surface layer comprising a functional face of complex shape constituting a negative of a composite part to be manufactured;
at least one reinforcing layer made of a composite material coated with a thermosetting material,
at least one first heating network configured to heat the functional face and to implement a thermal treatment surface for said composite part, and
at least one second heating network configured to heat the surface layer around the functional face and to define at least one thermal blocking belt at the at least one periphery of the thermal treatment surface.

2. The multilayer device according to claim 1, further comprising two reinforcing layers, the first heating network and the second heating network being arranged between the two reinforcing layers.

3. The multilayer device according to claim 1, further comprising at least three reinforcing layers, two first heating networks and the at least one second heating network, one of the first two heating networks and the at least one second heating network being arranged between two reinforcing layers arranged closest to the surface layer and the other one of the first two heating networks being arranged between two reinforcing layers arranged the farthest from the surface layer.

4. The multilayer device according to claim 1, wherein each of the at least one first heating network comprises a first support layer, at least one first heating cord fastened to the first support layer with an arrangement defining a heating surface corresponding to the thermal treatment surface and a first wire network electrically connected to the at least one first heating cord.

5. The multilayer device according to claim 4, wherein each of the at least one second heating network comprises a second support layer, at least one second heating cord fastened on the second support layer with an arrangement defining at least one thermal blocking belt at least at one periphery of the thermal treatment surface and a second wire network electrically connected to the at least one second heating cord.

6. The multilayer device according to claim 5, wherein the first support layer and the second support layer are made into one single support layer on which the at least one first heating cord and the at least one second heating cord are fastened.

7. The multilayer device according to claim 5, wherein the first support layer and the second support layer are designed in a dry fabric, preferably a fibrous material resistant to a temperature of at least 450° C., preferably glass fiber, carbon fiber, or basalt fiber.

8. The multilayer device according to claim 5, wherein each first or second heating cord comprises an electrically-insulating core made of dry fibers, preferably glass or basalt, on which a resistive wire is wound.

9. The multilayer device according to claim 1, wherein the at least one reinforcing layer is made of a material resistant to a temperature of at least 450° C., preferably glass fiber, carbon fiber, or basalt fiber.

10. The multilayer device according to claim 1, further comprising a metal mesh arranged between the surface layer and the at least one reinforcing layer, said metal mesh being connected to an electrical wire intended to be grounded.

11. The multilayer device according to claim 1, wherein the at least one first heating network comprises at least one first temperature measurement sensor, and the at least one second heating network comprises at least one second temperature measurement sensor.

12. The multilayer device according to claim 1, wherein the at least one first heating network is configured such that the thermal treatment surface features a division into heating areas dependent on variations in thickness and/or shape over the composite part to be manufactured and the at least one second heating network is configured such that the thermal blocking belt features a division into heating sections dependent on said heating areas and the shape of the boundary of the surface layer delimiting the functional face.

13. The multilayer device according to claim 12, wherein the at least one second heating network comprises one single second heating cord fastened on a second support layer, the division of the thermal blocking belt into heating sections being implemented by depositing said second heating cord over the second support layer with a variable step or using a second heating cord configured so as to have a variable linear ohmic value over its length.

14. The multilayer device according to claim 1, wherein the thermosetting material is configured to withstand temperatures of at least 400° C. preferably selected from among Cyanate-Ester resin. Phthalonitrile resin and ceramic.
